(19) United States
(12) Patent Application Publication
(10) Pub. No.: US 2025/0226914 A1
(43) Pub. Date: Jul. 10, 2025

(54) SCRAMBLING FOR NON-LINEAR CHANNEL ENCODERS

(71) Applicant: QUALCOMM Incorporated, San Diego, CA (US)

(72) Inventors: Wei YANG, San Diego, CA (US); Akash Sandeep DOSHI, San Diego, CA (US); June NAMGOONG, San Diego, CA (US); Pinar SEN, San Diego, CA (US); Taesang YOO, San Diego, CA (US); Jing JIANG, San Diego, CA (US)

(21) Appl. No.: 18/404,735

(22) Filed: Jan. 4, 2024

(51) Int. Cl. H04L 1/00; H04W 28/04

(52) U.S. Cl. CPC H04L 1/0033; H04W 28/04

(57) ABSTRACT

Some examples of the techniques described herein may address one or more issues for some non-linear channel codes (e.g., for artificial intelligence-based channel codes that are non-linear or that generate codes in the set of real numbers). Some of the techniques described herein, using a non-linear code with unequal error probabilities among codewords, may reduce error probability differences (e.g., may provide equal or approximately equal error probabilities) regardless of the messages to be transmitted while maintaining reduced average error probability. In some examples, scrambling may be performed to achieve reduced error probability differences among codewords for a non-linear code. Other scrambling approaches may be used to randomize inter-cell interference or to avoid biases in the generated codewords. In some approaches, scrambling may be performed after channel coding. Some examples of the techniques described herein may include performing scrambling before channel coding.

### FIELD OF TECHNOLOGY

The following relates to wireless communications, including scrambling for non-linear channel encoders.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

Some wireless communication systems may utilize channel codes to enhance communication reliability for signals transmitted between wireless devices. Channel coding using non-linear encoders may improve performance. Some non-linear encoders may be based on artificial intelligence (e.g., machine learning models, large language models (LLMs), among other examples). For instance, some artificial intelligence-based channel codes may include channel codes that are fully generated by artificial intelligence or classical channel codes augmented with artificial intelligence (e.g., turbo codes, polar codes, or Reed-Muller codes augmented with artificial intelligence).

Channel codes obtained using artificial intelligence may differ based on how the codes are generated. Some properties may be shared by various kinds of artificial intelligence-based channel codes. As described herein, some channel codes that are generated or augmented by artificial intelligence may be non-linear (unless linearity is imposed on an artificial intelligence model). In some examples, channel codes generated from artificial intelligence may include values from a set of real numbers, rather than binary numbers. Some artificial intelligence-based encoders may perform joint coding and modulation, which may enhance performance or efficiency relative to other codes.

Some examples of the techniques described herein may address one or more issues for some non-linear channel codes (e.g., for artificial intelligence-based channel codes that are non-linear or that generate codes in the set of real numbers). Some of the techniques described herein, using a non-linear code with unequal error probabilities among codewords, may reduce error probability differences (e.g., may provide equal or approximately equal error probabilities) regardless of the messages (e.g., information payload) to be transmitted while maintaining reduced average error probability. In some examples, scrambling (e.g., message-level scrambling) may be performed to achieve reduced error probability differences (e.g., to achieve an equal error probability) among codewords for a non-linear code. Other scrambling approaches may be used to randomize inter-cell interference or to avoid biases in the generated codewords. In some approaches, scrambling may be performed after channel coding. Some examples of the techniques described herein may include performing scrambling before channel coding. Some approaches to scrambling may be performed as a function of a cell identifier or device identifier (e.g., user equipment (UE) identifier) and may remain the same for transmissions coming from the same device. In some examples of the techniques described herein, the scrambling sequence may be changed from transmission to transmission.

In some approaches, bit-level scrambling may be performed on the coded information payload (e.g., after channel coding) to randomize the output of the channel coding. In some examples of the techniques described herein with artificial intelligence-based channel coding, the output of an artificial intelligence-based channel encoder may produce a real number output. For instance, a generated codeword may include real numbers or complex numbers (instead of bits). Some examples of the techniques described herein may perform scrambling (e.g., codeword-level scrambling) based on real number outputs from artificial intelligence-based encoders, which may randomize (e.g., reduce) inter-cell interference.

A method by a wireless device is described. The method may include scrambling a message sequence based on a scrambling configuration, encoding the scrambled message sequence based on a non-linear channel encoder configured to encode and modulate the scrambled message sequence to generate a code word, and transmitting a signal based on the code word generated from the non-linear channel encoder.

A wireless device is described. The wireless device may include one or more memories storing processor executable code, and one or more processors coupled with the one or more memories. The one or more processors may individually or collectively operable to execute the code to cause the wireless device to scramble a message sequence based on a scrambling configuration, encode the scrambled message sequence based on a non-linear channel encoder configured to encode and modulate the scrambled message sequence to generate a code word, and transmit a signal based on the code word generated from the non-linear channel encoder.

Another wireless device is described. The wireless device may include means for scrambling a message sequence based on a scrambling configuration, means for encoding the scrambled message sequence based on a non-linear channel encoder configured to encode and modulate the scrambled message sequence to generate a code word, and means for transmitting a signal based on the code word generated from the non-linear channel encoder.

A non-transitory computer-readable medium storing code is described. The code may include instructions executable by one or more processors to scramble a message sequence based on a scrambling configuration, encode the scrambled message sequence based on a non-linear channel encoder configured to encode and modulate the scrambled message sequence to generate a code word, and transmit a signal based on the code word generated from the non-linear channel encoder.

Some examples of the method, wireless devices, and non-transitory computer-readable medium described herein may further include operations, features, means, or instructions for communicating the scrambling configuration, the scrambling configuration indicating a change of a scrambling sequence between transmissions, where scrambling the message sequence includes scrambling the message sequence in accordance with the scrambling sequence.

Some examples of the method, wireless devices, and non-transitory computer-readable medium described herein may further include operations, features, means, or instructions for scrambling the message sequence may be based on a seed for generating pseudorandom information.

Some examples of the method, wireless devices, and non-transitory computer-readable medium described herein may further include operations, features, means, or instructions for generating the pseudorandom information based on the seed, the pseudorandom information including a pseudorandom binary sequence, a pseudorandom matrix, a pseudorandom permutation rule, a pseudorandom permutation function, or any combination thereof.

In some examples of the method, wireless devices, and non-transitory computer-readable medium described herein, the seed may be based on a time slot, a subslot, a frame, a subframe, a symbol index, a subcarrier index, a resource block index, an identifier of the wireless device, an identifier of a cell, a transmission index, or any combination thereof associated with transmission of the signal.

Some examples of the method, wireless devices, and non-transitory computer-readable medium described herein may further include operations, features, means, or instructions for scrambling the message sequence may be performed to reduce a per-message block error rate (BLER) spread of a set of message sequences that includes the message sequence.

Some examples of the method, wireless devices, and non-transitory computer-readable medium described herein may further include operations, features, means, or instructions for scrambling the code word based on a real number output from the non-linear channel encoder, where the signal may be based on the scrambled code word.

In some examples of the method, wireless devices, and non-transitory computer-readable medium described herein, scrambling the code word may include operations, features, means, or instructions for scrambling the code word based on a pseudorandom phase that may be based on a seed.

In some examples of the method, wireless devices, and non-transitory computer-readable medium described herein, the seed may be based on a slot index, a subcarrier index, a location within the code word, an identifier of a cell, or any combination thereof.

In some examples of the method, wireless devices, and non-transitory computer-readable medium described herein, scrambling the code word may include operations, features, means, or instructions for transforming real numbers of the real number output in the code word to a complex number and multiplying the complex number by the pseudorandom phase to generate the scrambled code word, where the signal may be based on the scrambled code word.

In some examples of the method, wireless devices, and non-transitory computer-readable medium described herein, the non-linear channel encoder may be an artificial intelligence-based channel encoder.

A method by a wireless device is described. The method may include encoding a message sequence based on a non-linear channel encoder configured to encode and modulate the message sequence to generate a code word, scrambling the code word based on a real number output from the non-linear channel encoder, and transmitting a signal based on the scrambled code word.

A wireless device is described. The wireless device may include one or more memories storing processor executable code, and one or more processors coupled with the one or more memories. The one or more processors may individually or collectively operable to execute the code to cause the wireless device to encode a message sequence based on a non-linear channel encoder configured to encode and modulate the message sequence to generate a code word, scramble the code word based on a real number output from the non-linear channel encoder, and transmit a signal based on the scrambled code word.

Another wireless device is described. The wireless device may include means for encoding a message sequence based on a non-linear channel encoder configured to encode and modulate the message sequence to generate a code word, means for scrambling the code word based on a real number output from the non-linear channel encoder, and means for transmitting a signal based on the scrambled code word.

A non-transitory computer-readable medium storing code is described. The code may include instructions executable by one or more processors to encode a message sequence based on a non-linear channel encoder configured to encode and modulate the message sequence to generate a code word, scramble the code word based on a real number output from the non-linear channel encoder, and transmit a signal based on the scrambled code word.

In some examples of the method, wireless devices, and non-transitory computer-readable medium described herein, scrambling the code word may include operations, features, means, or instructions for scrambling the code word based on a pseudorandom phase that may be based on a seed.

In some examples of the method, wireless devices, and non-transitory computer-readable medium described herein, the seed may be based on a slot index, a subcarrier index, a location within the code word, an identifier of a cell, or any combination thereof.

In some examples of the method, wireless devices, and non-transitory computer-readable medium described herein, scrambling the code word may include operations, features, means, or instructions for transforming real numbers of the real number output in the code word to a complex number and multiplying the complex number by the pseudorandom phase to generate the scrambled code word, where the signal may be based on the scrambled code word.

Some examples of the method, wireless devices, and non-transitory computer-readable medium described herein may further include operations, features, means, or instructions for scrambling the message sequence based on a scrambling configuration, where encoding the message sequence includes encoding the scrambled message sequence.

Some examples of the method, wireless devices, and non-transitory computer-readable medium described herein may further include operations, features, means, or instructions for communicating the scrambling configuration, the scrambling configuration indicating a change of a scrambling sequence between transmissions, where scrambling the message sequence includes scrambling the message sequence in accordance with the scrambling sequence.

Some examples of the method, wireless devices, and non-transitory computer-readable medium described herein may further include operations, features, means, or instructions for scrambling the message sequence may be based on a seed for generating pseudorandom information.

Some examples of the method, wireless devices, and non-transitory computer-readable medium described herein may further include operations, features, means, or instructions for generating the pseudorandom information based on the seed, the pseudorandom information including a pseudorandom binary sequence, a pseudorandom matrix, a pseudorandom permutation rule, a pseudorandom permutation function, or any combination thereof.

In some examples of the method, wireless devices, and non-transitory computer-readable medium described herein, the seed may be based on a time slot, a subslot, a frame, a subframe, a symbol index, a subcarrier index, a resource block index, an identifier of the wireless device, an identifier of a cell, a transmission index, or any combination thereof associated with transmission of the signal.

Some examples of the method, wireless devices, and non-transitory computer-readable medium described herein may further include operations, features, means, or instructions for scrambling the message sequence may be performed to reduce a per-message block error rate (BLER) spread of a set of message sequences that includes the message sequence.

In some examples of the method, wireless devices, and non-transitory computer-readable medium described herein, the non-linear channel encoder may be an artificial intelligence-based channel encoder.

### BRIEF DESCRIPTION OF THE DRAWINGS

FIG. 1 shows an example of a wireless communications system that supports scrambling for non-linear channel encoders in accordance with one or more aspects of the present disclosure.

FIG. 2 shows an example of a wireless communications system that supports scrambling for non-linear channel encoders in accordance with one or more aspects of the present disclosure.

FIG. 3 shows an example of a wireless communications system that supports scrambling for non-linear channel encoders in accordance with one or more aspects of the present disclosure.

FIG. 4 shows an example of a process flow that supports scrambling for non-linear channel encoders in accordance with one or more aspects of the present disclosure.

FIGS. 5 and 6 show block diagrams of devices that support scrambling for non-linear channel encoders in accordance with one or more aspects of the present disclosure.

FIG. 7 shows a block diagram of a communications manager that supports scrambling for non-linear channel encoders in accordance with one or more aspects of the present disclosure.

FIG. 8 shows a diagram of a system including a device that supports scrambling for non-linear channel encoders in accordance with one or more aspects of the present disclosure.

FIGS. 9 through 12 show flowcharts illustrating methods that support scrambling for non-linear channel encoders in accordance with one or more aspects of the present disclosure.

### DETAILED DESCRIPTION

Some wireless communication systems may utilize channel codes to enhance communication reliability for signals transmitted between wireless devices. Many channel codes used in communication systems (e.g., Long Term Evolution (LTE), Fifth-generation wireless (5G), New Radio (NR), Wi-Fi, and Ethernet, among other examples) are linear codes. With linear codes, an error probability of each codeword or payload may be equal as a property of linearity.

Channel coding using non-linear encoders may improve performance. Some non-linear encoders may be based on artificial intelligence (e.g., machine learning models, large language models (LLMs), among other examples). For instance, some artificial intelligence-based channel codes may include channel codes that are fully generated by artificial intelligence or classical channel codes augmented with artificial intelligence (e.g., turbo codes, polar codes, or Reed-Muller codes augmented with artificial intelligence).

Channel codes obtained using artificial intelligence may differ based on how the codes are generated. Some properties may be shared by various kinds of artificial intelligence-based channel codes. As described herein, some channel codes that are generated or augmented by artificial intelligence may be non-linear (unless linearity is imposed on an artificial intelligence model). In some examples, channel codes generated from artificial intelligence may include values from a set of real numbers, rather than binary numbers. Some artificial intelligence-based encoders may perform joint coding and modulation, which may enhance performance or efficiency relative to other codes.

As a result of non-linearity, per-codeword error probabilities of codes generated or augmented by artificial intelligence may differ between messages or between codewords, which may be a general issue for non-linear codes. For example, a plot of per-codeword error probability versus signal-to-noise ratio (SNR) for an artificial intelligence-based or machine learning-based (11, 32) code with maximum likelihood (ML) decoding may exhibit greater than a 0.5 decibel (dB) spread at a block error rate (BLER) of 1-3. The artificial-intelligence-based (11, 32) code may outperform a linear block (11, 32) code by approximately 0.2 dB in average error probability, which may imply that some message sequences have a higher error probability. Mapping these message sequences to one or more different codewords may reduce the corresponding error probabilities.

Some examples of the techniques described herein may address one or more issues for some non-linear channel codes (e.g., for artificial intelligence-based channel codes that are non-linear or that generate codes in the set of real numbers). Some of the techniques described herein, using a non-linear code with unequal error probabilities among codewords, may reduce error probability differences (e.g., may provide equal or approximately equal error probabilities) regardless of the messages (e.g., information payload) to be transmitted while maintaining reduced average error probability. In some examples, scrambling (e.g., message-level scrambling) may be performed to achieve reduced error probability differences (e.g., to achieve an equal error probability) among codewords for a non-linear code. Other scrambling approaches may be used to randomize inter-cell interference or to avoid biases in the generated codewords. In some approaches, scrambling may be performed after channel coding. Some examples of the techniques described herein may include performing scrambling before channel coding. Some approaches to scrambling may be performed as a function of a cell identifier or device identifier (e.g., UE identifier) and may remain the same for transmissions coming from the same device. In some examples of the techniques described herein, the scrambling sequence may be changed from transmission to transmission.

In some approaches, bit-level scrambling may be performed on the coded information payload (e.g., after channel coding) to randomize the output of the channel coding. In some examples of the techniques described herein with artificial intelligence-based channel coding, the output of an artificial intelligence-based channel encoder may produce a real number output. For instance, a generated codeword may include real numbers or complex numbers (instead of bits). Some examples of the techniques described herein may perform scrambling (e.g., codeword-level scrambling or phase scrambling) based on real number outputs from artificial intelligence-based encoders, which may randomize (e.g., reduce) inter-cell interference.

Aspects of the disclosure are initially described in the context of wireless communications systems. Aspects of the disclosure are further illustrated by and described with reference to a process flow. Aspects of the disclosure are further illustrated by and described with reference to apparatus diagrams, system diagrams, and flowcharts that relate to scrambling for non-linear channel encoders.

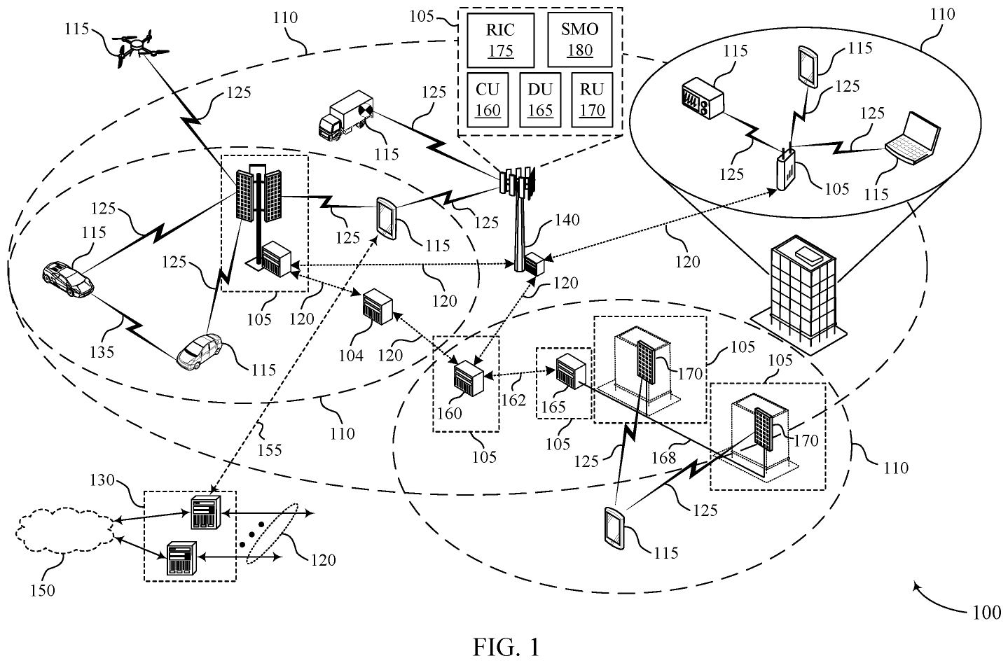

FIG. 1 shows an example of a wireless communications system 100 that supports scrambling for non-linear channel encoders in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support scrambling for non-linear channel encoders as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communication systems may utilize channel codes to enhance communication reliability for signals transmitted between wireless devices. Many channel codes used in communication systems (e.g., LTE, 5G, Wi-Fi, and Ethernet, among other examples) are linear codes. With linear codes, an error probability of each codeword or payload may be equal as a property of linearity.

Channel coding using non-linear encoders may improve performance. Some non-linear encoders may be based on artificial intelligence (e.g., machine learning models, LLMs, among other examples). For instance, some artificial intelligence-based channel codes may include channel codes that are fully generated by artificial intelligence or classical channel codes augmented with artificial intelligence (e.g., turbo codes, polar codes, or Reed-Muller codes augmented with artificial intelligence).

Channel codes obtained using artificial intelligence may differ based on how the codes are generated. Some properties may be shared by various kinds of artificial intelligence-based channel codes. As described herein, some channel codes that are generated or augmented by artificial intelligence may be non-linear (unless linearity is imposed on an artificial intelligence model). In some examples, channel codes generated from artificial intelligence may include values from a set of real numbers, rather than binary numbers. Some artificial intelligence-based encoders may perform joint coding and modulation, which may enhance performance or efficiency relative to other codes.

As a result of non-linearity, per-codeword error probabilities of codes generated or augmented by artificial intelligence may differ between messages or between codewords, which may be a general issue for non-linear codes. For example, a plot of per-codeword error probability versus signal-to-noise ratio (SNR) for an artificial intelligence-based (11, 32) code with maximum likelihood (ML) decoding may exhibit greater than a 0.5 decibel (dB) spread at a block error rate (BLER) of 1-3. The artificial-intelligence-based (11, 32) code may outperform a linear block (11, 32) code by approximately 0.2 dB in average error probability, which may imply that some message sequences have a higher error probability. Mapping these message sequences to one or more different codewords may reduce the corresponding error probability.

Some examples of the techniques described herein may address one or more issues for some non-linear channel codes (e.g., for artificial intelligence-based channel codes that are non-linear or that generate codes in the set of real numbers). Some of the techniques described herein, using a non-linear code with unequal error probabilities among codewords, may reduce error probability differences (e.g., may provide equal or approximately equal error probabilities) regardless of the messages (e.g., information payload) to be transmitted while maintaining reduced average error probability.

In some examples, scrambling (e.g., message-level scrambling) may be performed to achieve reduced error probability differences (e.g., to achieve an equal error probability) among codewords for a non-linear code. Other scrambling approaches may be used to randomize inter-cell interference or to avoid biases in the generated codewords. In some approaches, scrambling may be performed after channel coding. Some examples of the techniques described herein may include performing scrambling before channel coding. Some approaches to scrambling may be performed as a function of a cell identifier or device identifier (e.g., UE identifier) and may remain the same for transmissions coming from the same device. In some examples of the techniques described herein, the scrambling sequence may be changed from transmission to transmission.

In some aspects, a network entity 105 or a UE 115 may perform scrambling or channel coding in accordance with one or more of the approaches described herein. For instance, a network entity 105 or a UE 115 may perform scrambling before channel coding, scrambling after channel coding, or a combination thereof.

In some approaches, bit-level scrambling may be performed on the coded information payload (e.g., after channel coding) to randomize the output of the channel coding. In some examples of the techniques described herein with artificial intelligence-based channel coding, the output of an artificial intelligence-based channel encoder may produce a real number output. For instance, a generated codeword may include real numbers or complex numbers (instead of bits). Some examples of the techniques described herein may perform scrambling (e.g., codeword-level scrambling) based on real number outputs from artificial intelligence-based encoders, which may randomize (e.g., reduce) inter-cell interference.

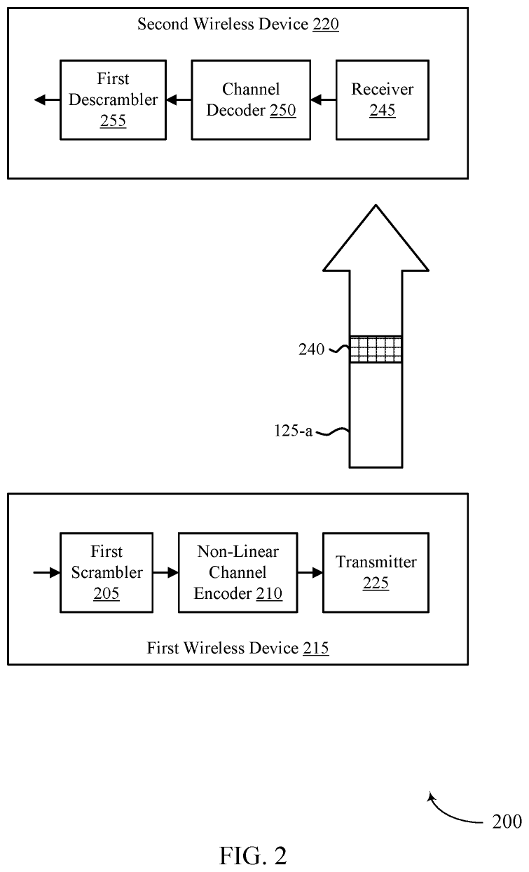

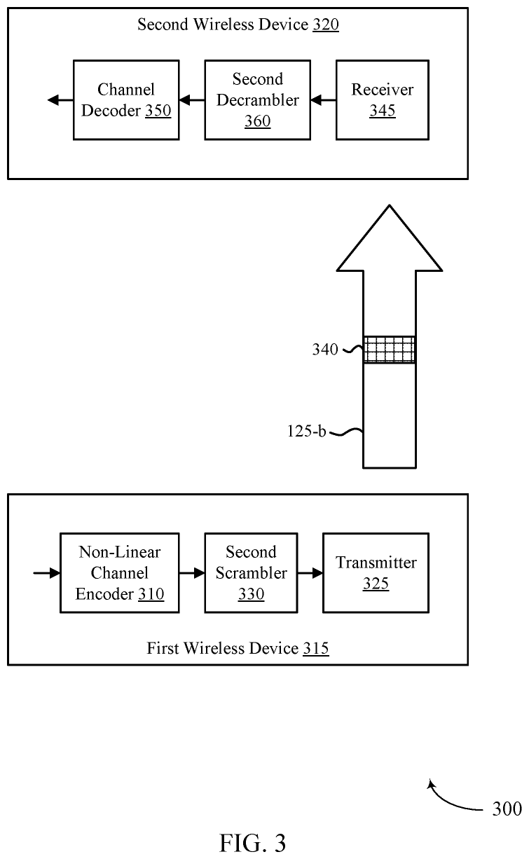

FIG. 2 shows an example of a wireless communications system 200 that supports scrambling for non-linear channel encoders in accordance with one or more aspects of the present disclosure. In some examples, the wireless communications system 200 may implement aspects of or may be implemented by aspects of the wireless communications system 100. For instance, the wireless communications system 200 may include a first wireless device 215 or a second wireless device 220. In some aspects, the first wireless device 215 may be an example of a UE 115 as described with reference to FIG. 1 or the second wireless device 220 may be an example of a network entity 105 as described with reference to FIG. 1. In some aspects, the second wireless device 220 may be an example of a UE 115 as described with reference to FIG. 1 or the first wireless device 215 may be an example of a network entity 105 as described with reference to FIG. 1. In some aspects, the first wireless device 215 may be an example of the first wireless device 315 as described with reference to FIG. 3 or the second wireless device 220 may be an example of the second wireless device 320 as described with reference to FIG. 3.

The first wireless device 215 may communicate with the second wireless device 220 using a communication link 125-a, which may be an example of a communication link 125 described with reference to FIG. 1. The communication link 125-a may include a unidirectional or bidirectional link that enables communication between the first wireless device 215 and the second wireless device 220 (e.g., uplink or downlink network communications). For example, the first wireless device 215 may transmit one or more transmissions (e.g., uplink or downlink control signals or data signals), to the second wireless device 220 using the communication link 125-a. In some examples, the second wireless device 220 may transmit one or more transmissions (e.g., downlink or uplink control signals or data signals), to the first wireless device 215 using the communication link 125-a.

The first wireless device 215 may include a first scrambler 205, a non-linear channel encoder 210, or a transmitter 225. The first scrambler 205, the non-linear channel encoder 210, or the transmitter 225 may be implemented in one or more circuitries (e.g., integrated circuitry, a field-programmable gate array (FPGA), an application-specific integrated circuitry (ASIC), or a processor with instructions, among other examples).

The second wireless device 220 may include a receiver 245, a channel decoder 250, or a first descrambler 255. The receiver 245, channel decoder 250, or first descrambler 255 may be implemented in one or more circuitries (e.g., integrated circuitry, a FPGA, an ASIC, or a processor with instructions, among other examples).

The first scrambler 205 may scramble a message sequence based on a scrambling configuration. A message sequence may be a sequence of values (e.g., bits, information, data, or signal information, among other examples). A message sequence may represent (e.g., may represent a portion of) voice, audio, video, text, or other data. In some examples, the message sequence may be expressed as u ∈{1, −1}^{k}. Scrambling the message sequence may generate a scrambled message sequence (e.g., u′).

A scrambling configuration may be information indicating one or more aspects for scrambling. For example, a scrambling configuration may indicate a change of a scrambling sequence (for changing a scrambling sequence between transmissions, for instance), a seed for generating pseudorandom information, a pseudorandom sequence (e.g., a pseudorandom binary sequence), a pseudorandom matrix (e.g., P), a pseudorandom function, a pseudorandom permutation rule, or any combination thereof.

In some examples, the first wireless device 215 may communicate the scrambling configuration. As used herein, the term “communicate” and variations thereof may mean “transmit,” “receive,” or a combination thereof. For instance, the first wireless device 215 may transmit the scrambling configuration or may receive the scrambling configuration. In some approaches, the first wireless device 215 may transmit the scrambling configuration to the second wireless device 220, which may receive the scrambling configuration to coordinate scrambling and descrambling. In some approaches, the second wireless device 220 may transmit the scrambling configuration to the first wireless device 215, which may receive the scrambling configuration to coordinate the scrambling performed at the first wireless device 215 with descrambling performed at the second wireless device 220.

In some aspects, the scrambling configuration may indicate a change of a scrambling sequence between transmissions. For example, the change of scrambling sequence may be indicated as a rule, an index, or other information that establishes one or changes to a scrambling sequence for one or more respective transmissions. Changing the scrambling sequence between transmissions may change the association between each message sequence and codeword (to enable a message sequence to be associated with a different codeword between transmissions, for example). Changing the scrambling sequence between transmissions may help the average error probability associated with each message to be approximately equal. Scrambling the message sequence may include scrambling the message sequence in accordance with the scrambling sequence. In some examples, the second wireless device 220 (e.g., the first descrambler 255) may change the scrambling sequence in accordance with the change(s) of the scrambling sequence (as indicated by the scrambling configuration, for instance) for descrambling.

In some approaches, scrambling the message sequence may be based on a seed for generating pseudorandom information. For example, the first scrambler may utilize a seed to generate a pseudorandom scrambling sequence (e.g., pseudorandom binary scrambling sequence), a matrix, a pseudorandom permutation rule, or a pseudorandom permutation function. The seed may be based on (e.g., may be determined based on one or more or) a time slot, a subslot, a frame, a subframe, a symbol index (e.g., a first OFDM symbol index, a last OFDM symbol index, or another symbol index), a subcarrier index (e.g., a first subcarrier index, a last subcarrier index, or another subcarrier index), a resource block or resource block index (e.g., a first or last physical resource block (PRB), another PRB, a first PRB index, a last PRB index, or another PRB index), an identifier of a wireless device (e.g., an identifier of the first wireless device 215, an identifier of the second wireless device 220, or a UE identifier), an identifier of a cell (e.g., an identifier of a cell or a network entity), a transmission index (e.g., an index of a transmission of a signal 240 in a case that transmissions are indexed), other information, or any combination thereof. The time slot, subslot, frame, subframe, symbol index, subcarrier index, resource block or resource block index, identifier of a wireless device, identifier of a cell, transmission index, or other information may be associated with the transmission of a signal 240.

The first wireless device 215 (e.g., the first scrambler 205) may generate the pseudorandom information based on the seed. The pseudorandom information may include a pseudorandom binary sequence, a pseudorandom matrix, a pseudorandom permutation rule, or any combination thereof.

In some examples, the first scrambler 205 may scramble a message sequence (e.g., u) using a k-length pseudorandom sequence (e.g., a pseudorandom binary sequence or a Gold sequence, among other examples). In some approaches, the first descrambler 255 may utilize the k-length pseudorandom sequence to perform corresponding descrambling on the second wireless device 220. For instance, the scrambling configuration may indicate the seed or the pseudorandom sequence, which the first descrambler 255 may utilize for descrambling.

In some examples, the first scrambler 205 may scramble a message sequence by multiplying the message sequence (e.g., u) by a k×k invertible pseudorandom matrix (e.g., P). An invertible transformation (e.g., multiplying the message sequence by the k×k pseudorandom matrix) may be undone at the second wireless device 220 when the second wireless device 220 has the pseudorandom matrix (e.g., P). For instance, the first descrambler 255 may utilize the pseudorandom matrix to perform corresponding descrambling on the second wireless device 220. In some aspects, the scrambling configuration may indicate the seed or the pseudorandom matrix, which the first descrambler 255 may utilize for descrambling.

In some examples, the first scrambler 205 may permute or interleave the information bits in the message sequence (e.g., u) with a pseudorandom permutation function or with a pseudorandom permutation rule. In some approaches, the first descrambler 255 may utilize the pseudorandom permutation function or the pseudorandom permutation rule to perform corresponding descrambling on the second wireless device 220. In some aspects, the scrambling configuration may indicate the seed, the pseudorandom permutation rule, or the pseudorandom permutation function, which the first descrambler 255 may utilize for descrambling.

In some aspects, the scrambling performed on the message sequence may be referred to as message-level scrambling. For instance, the message sequence may be scrambled before encoding. Scrambling the message sequence may be performed to reduce a per-message block error rate (BLER) spread of a set of message sequences that includes the message sequence. For example, the message sequence may be scrambled to ensure that each message sequence (e.g., u) has approximately the same error probability.

The first wireless device 215 may encode the scrambled message sequence (e.g., u′) based on the non-linear channel encoder 210. The non-linear channel encoder 210 may be configured to encode and modulate the scrambled message sequence to generate a codeword (e.g., c). For instance, the non-linear channel encoder 210 may perform encoding and modulation operations. In some aspects, the first wireless device 215 may not include a separate modulator for modulating the message sequence (e.g., the scrambled message sequence). For example, the first wireless device 215 may omit a quadrature amplitude modulation (QAM) modulator or may skip performing QAM modulation due to the non-linear channel encoder 210. In some examples, the non-linear channel encoder 210 may generate one or more complex symbols (e.g., OFDM or DFT-S-OFDM symbols, among other examples). Additionally, or alternatively, the codeword(s) generated by the non-linear channel encoder 210 may be utilized to generate one or more complex symbols. For instance, a first codeword may be mapped to an in-phase (I) dimension or channel, and a second codeword may be mapped to a quadrature (Q) dimension or channel.

In some examples, the non-linear channel encoder 210 may be an artificial intelligence-based channel encoder. For instance, the non-linear channel encoder 210 may be implemented based on one or more artificial intelligence or machine learning models. Some examples of the models that may be utilized for the non-linear channel encoder 210 may include one or more transformer models, one or more LLMs, or one or more generative artificial intelligence models, among other examples. Some examples of the techniques described herein may include or support artificial intelligence-based channel coding or machine learning-based channel coding.

The first wireless device 215 may transmit a signal 240 based on the codeword generated from the non-linear channel encoder 210. For example, the transmitter 225 may utilize one or more antennas to radiate the signal 240, where the signal 240 is based on (e.g., derived from) the codeword generated from the non-linear channel encoder 210. The signal 240 may be transmitted via the communication link 125-a.

The second wireless device 220 (e.g., the receiver 245) may receive the signal 240. For instance, the receiver 245 may utilize one or more antennas to receive the signal 240. The signal 240 (or another signal based on the signal 240) may be provided to the channel decoder 250. The channel decoder 250 may perform decoding based on the signal 240. For example, the channel decoder 250 may demodulate or decode the signal 240 (or another signal based on the signal 240). In some examples, the channel decoder 250 may be an artificial intelligence-based channel decoder. For instance, the channel decoder 250 may be implemented based on artificial intelligence or machine learning models. Some examples of the models that may be utilized for the channel decoder 250 may include one or more transformer models, one or more LLMs, or one or more generative artificial intelligence models, among other examples. In some examples, the channel decoder 250 may be another type of decoder (e.g., a turbo decoder, block decoder, convolutional decoder, among other examples). The channel decoder 250 may generate a decoded signal.

The first descrambler 255 may perform descrambling as described herein. For instance, the first descrambler 255 may undo or reverse the scrambling operation(s) based on a pseudorandom sequence (e.g., pseudorandom binary sequence), a pseudorandom matrix, a pseudorandom permutation rule, or a pseudorandom permutation function. The first descrambler 255 may generate a descrambled message sequence. For instance, the first descrambler 255 may generate descrambled voice, audio, video, data, or other information.

In some approaches, the first wireless device 215 may perform other scrambling (e.g., scrambling based on a codeword from the non-linear channel encoder 210). For instance, the first wireless device 215 may include a second scrambler (e.g., second scrambler 330, not shown in FIG. 2) between the non-linear channel encoder 210 and the transmitter 225 in some aspects.

In some examples, the second scrambler may scramble the codeword based on a real number output from the non-linear channel encoder 210. For instance, the non-linear channel encoder 210 may produce a codeword that is in the set of real numbers (e.g., c ∈ [symbol] ⁿ). The signal 240 may be based on the scrambled codeword.

In some examples, scrambling the codeword may include scrambling the codeword based on a pseudorandom phase that is based on a seed (e.g., the same seed as described with reference of the first scrambler 205 or a different seed). For instance, the seed may be based on a slot index, a subcarrier index, a location within the codeword, an identifier of a cell, or any combination thereof.

In some examples, scrambling the codeword may include transforming real numbers of the real number output in the codeword to a complex number. Scrambling the codeword may also include multiplying the complex number by the pseudorandom phase to generate the scrambled codeword. The signal 240 may be based on the scrambled codeword. Additional details regarding the codeword scrambling (e.g., codeword scrambling with a second scrambler) are provided with reference to FIG. 3.

FIG. 3 shows an example of a wireless communications system 300 that supports scrambling for non-linear channel encoders in accordance with one or more aspects of the present disclosure. In some examples, the wireless communications system 300 may implement aspects of or may be implemented by aspects of the wireless communications system 100 or the wireless communications system 200. The wireless communications system 300 may include a first wireless device 315 or a second wireless device 320. In some aspects, the first wireless device 315 may be an example of a UE 115 as described with reference to FIG. 1 or the second wireless device 320 may be an example of a network entity 105 as described with reference to FIG. 1. In some aspects, the second wireless device 320 may be an example of a UE 115 as described with reference to FIG. 1 or the first wireless device 315 may be an example of a network entity 105 as described with reference to FIG. 1. In some aspects, the first wireless device 315 may be an example of the first wireless device 215 as described with reference to FIG. 2 or the second wireless device 320 may be an example of the second wireless device 220 as described with reference to FIG. 2.

The first wireless device 315 may communicate with the second wireless device 320 using a communication link 125-b, which may be an example of a communication link 125 described with reference to FIG. 1. The communication link 125-b may include a unidirectional or bidirectional link that enables communication between the first wireless device 315 and the second wireless device 320 (e.g., uplink or downlink network communications). For example, the first wireless device 315 may transmit one or more transmissions (e.g., uplink or downlink control signals or data signals), to the second wireless device 320 using the communication link 125-b. In some examples, the second wireless device 320 may transmit one or more transmissions (e.g., downlink or uplink control signals or data signals), to the first wireless device 315 using the communication link 125-b.

The first wireless device 315 may include a non-linear channel encoder 310, a second scrambler 330, or a transmitter 325. The second scrambler 330, the non-linear channel encoder 310, or the transmitter 325 may be implemented in one or more circuitries (e.g., integrated circuitry, a FPGA, an ASIC, or a processor with instructions, among other examples). In some aspects, the non-linear channel encoder 310 may be an example of the non-linear channel encoder 210 described with reference to FIG. 2. In some aspects, the second scrambler 330 may be an example of the second scrambler described with reference to FIG. 2. In some aspects, the transmitter 325 may be an example of the transmitter 225 described with reference to FIG. 2.

The second wireless device 320 may include a receiver 345, a second descrambler 360, or a channel decoder 350. The receiver 345, channel decoder 350, or second descrambler 360 may be implemented in one or more circuitries (e.g., integrated circuitry, a FPGA, an ASIC, or a processor with instructions, among other examples). In some aspects, the receiver 345 may be an example of the receiver 245 described with reference to FIG. 2. In some aspects, the second scrambler may be included in the second wireless device 220 described with reference to FIG. 2. In some aspects, the channel decoder 350 may be an example of the channel decoder 250 described with reference to FIG. 2.

The first wireless device 315 may encode a message sequence based on a non-linear channel encoder 310 configured to encode and modulate the message sequence to generate a codeword. In some examples, the non-linear channel encoder 310 may encode the message sequence (with or without scrambling provided for a first scrambler, for instance) as described with reference to FIG. 1. For example, the non-linear channel encoder 310 may encode a message sequence (e.g., u without previous scrambling) or may encode a scrambled message sequence (u′ with previous scrambling) to generate a codeword. In some examples, the non-linear channel encoder 310 may be an artificial intelligence-based channel encoder as described herein.

The second scrambler 330 may scramble the codeword based on a real number output from the non-linear channel encoder 310. For instance, the non-linear channel encoder 310 may produce a codeword that is in the set of real numbers (e.g., c ∈ [symbol] ⁿ). The set of real numbers may not be constrained to binary values (e.g., 0 and 1, or −1 and 1) as channel coding bits produced by other encoders. In some aspects, the scrambling performed on the codeword(s) may be referred to as codeword-level scrambling or phase scrambling. For instance, the codeword(s) may be scrambled after encoding. The codeword-level scrambling may be performed at a higher level relative to a bit level (e.g., higher than bit-level scrambling). For example, the second scrambler 330 may perform real number scrambling, instead of bit-level scrambling.

In some examples, the second scrambler 330 may scramble the codeword based on a pseudorandom phase that is based on a seed. For instance, the seed may be based on a slot index, a subcarrier index, a location within the codeword, an identifier of a cell, other information, or any combination thereof. In some examples, the seed, slot index, subcarrier index, location within a codeword, identifier of a cell, or other information may be indicated in a scrambling configuration (e.g., the scrambling configuration as described with reference to FIG. 2 or a different scrambling configuration). For instance, the first wireless device 315 or the second wireless device 320 may communicate the scrambling configuration as described herein. The first wireless device 315 may transmit the scrambling configuration or may receive the scrambling configuration. In some approaches, the first wireless device 315 may transmit the scrambling configuration to the second wireless device 320, which may receive the scrambling configuration to coordinate scrambling and descrambling. In some approaches, the second wireless device 320 may transmit the scrambling configuration to the first wireless device 315, which may receive the scrambling configuration to coordinate the scrambling performed at the first wireless device 315 with descrambling performed at the second wireless device 320.

In some approaches, scrambling the codeword may include transforming real numbers of the real number output in the codeword to a complex number. For example, the first wireless device 315 (e.g., second scrambler 330) may group two consecutive real numbers in each codeword as one complex number si, where one codeword is mapped to an in-phase (I) dimension or channel and another codeword is mapped to a quadrature (Q) dimension or channel.

In some examples, scrambling the codeword may include multiplying the complex number by the pseudorandom phase to generate the scrambled codeword (e.g., c′). For instance, the second scrambler 330 may multiply each complex number by a pseudorandom phase e^{jθi}. In some aspects, the second scrambler 330 may utilize a random seed to generate the pseudorandom phase as a function of a slot index, subcarrier index, location within a codeword (e.g., i), identifier of a cell, or other information.

Some examples of phase sequences for scrambling the codeword may include random phase-shift keying (PSK) sequences (e.g., quadrature phase shift keying (QPSK), 8-phase shift keying (8PSKs), or 16-phase shift keying (16PSK), among other examples). In some aspects, a random phase sequence may be modulated from a pseudorandom sequence (e.g., pseudorandom binary sequence or Gold sequence, among other examples) or may be directly generated PSK sequences. Other examples of phase sequences may include discrete Fourier transform (DFT) sequences, Zadoff-Chu sequences, or other sequences.

A signal 340 may be based on the scrambled codeword. For example, the first wireless device 315 may transmit a signal 340 based on the scrambled codeword (generated from the second scrambler 330, for instance). For example, the transmitter 325 may utilize one or more antennas to radiate the signal 340, where the signal 340 is based on (e.g., derived from) the scrambled codeword generated from the second scrambler 330. The signal 340 may be transmitted via the communication link 125-b.

The second wireless device 320 (e.g., the receiver 345) may receive the signal 340. For instance, the receiver 345 may utilize one or more antennas to receive the signal 340. The signal 340 (or another signal based on the signal 340) may be provided to the second descrambler 360.

The second descrambler 360 may perform descrambling as described herein. For instance, the second descrambler 360 may undo or reverse the scrambling operation(s) based on a phase sequence. The second descrambler 360 may generate one or more descrambled codewords.

The channel decoder 350 may perform decoding based on the signal 340 (e.g., based on the descrambled codeword(s)). For example, the channel decoder 350 may demodulate or decode the signal 340 (or another signal based on the signal 340). In some examples, the channel decoder 350 may be an artificial intelligence-based channel decoder. For instance, the channel decoder 350 may be implemented based on artificial intelligence or machine learning models. Some examples of the models that may be utilized for the channel decoder 350 may include one or more transformer models, one or more LLMs, or one or more generative artificial intelligence models, among other examples. In some examples, the channel decoder 350 may be another type of decoder (e.g., a turbo decoder, block decoder, convolutional decoder, among other examples). The channel decoder 350 may generate a decoded signal (e.g., one or more decoded scrambled messages in some approaches).

In some approaches, the first wireless device 315 may perform other scrambling (e.g., scrambling based on a message sequence). For instance, the first wireless device 315 may include a first scrambler (e.g., first scrambler 205, not shown in FIG. 3) before the non-linear channel encoder 310 in some aspects. For example, scrambling, encoding, transmitting, receiving, descrambling, or decoding may be performed based on one or more message sequences or one or more codewords.

In some examples, the first wireless device 315 may perform message-level scrambling (before non-linear channel encoding, for instance) as described with reference to FIG. 2. In some aspects, the first wireless device 315 (e.g., a first scrambler 205) may scramble the message sequence based on a scrambling configuration, where encoding the message sequence includes encoding the scrambled message sequence. For instance, the first wireless device 315 may include a first scrambler (e.g., the first scrambler 205), a second scrambler (e.g., the second scrambler 330), or both. The first wireless device 315 may perform message-level scrambling, codeword-level (or phase) scrambling, or both.

In some aspects, the first wireless device 315 may communicate the scrambling configuration as described herein. For example, the scrambling configuration may indicate a change of a scrambling sequence between transmissions, where scrambling the message sequence may include scrambling the message sequence in accordance with the scrambling sequence.

In some approaches, scrambling the message sequence may be based on a seed for generating pseudorandom information. For example, the first wireless device 315 may generate the pseudorandom information based on the seed. The pseudorandom information may include a pseudorandom binary sequence, a pseudorandom matrix, a pseudorandom permutation rule, a pseudorandom permutation function, or any combination thereof. In some aspects, the seed may be based on a time slot, a subslot, a frame, a subframe, a symbol index, a subcarrier index, a resource block index, an identifier of the wireless device, an identifier of a cell, a transmission index, or any combination thereof associated with transmission of the signal 340. As described herein, scrambling the message sequence may be performed to reduce a per-message BLER spread of a set of message sequences that includes the message sequence.

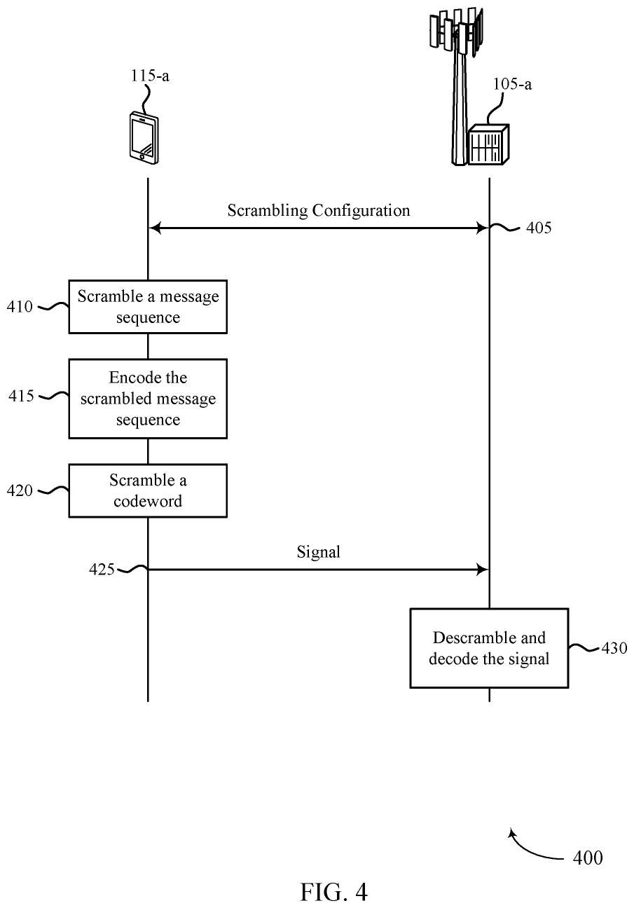

FIG. 4 shows an example of a process flow 400 that supports scrambling for non-linear channel encoders in accordance with one or more aspects of the present disclosure. A wireless communications system may include a UE 115-a and a network entity 105-a. In some examples, the UE 115-a may be an example of the UEs 115, the first wireless device 215, or the first wireless device 315, and the network entity 105-a may be an example of the network entities 105, the second wireless device 220, or the second wireless device 320, as described herein.

In the following description of the process flow 400, the communications between the network entity 105-a and the UE 115-a may be transmitted in a different order than the example order shown, or the operations performed by the network entity 105-a and the UE 115-a may be performed in different orders or at different times. Some operations may be omitted from the process flow 400, or other operations may be added to the process flow 400. Further, although some operations or signaling may be shown to occur at different times for discussion purposes, these operations may actually occur at the same time or in overlapping time periods in some examples.

At 405, the UE 115-a or the network entity 105-a may communicate (e.g., transmit or receive) a scrambling configuration. For example, the UE 115-a or the network entity 105-a may communicate the scrambling configuration as described with reference to one or more of FIG. 2 and FIG. 3.

At 410, the UE 115-a may scramble one or more message sequences. For example, the UE 115-a may scramble one or more message sequences as described with reference to one or more of FIG. 2 and FIG. 3.

At 415, the UE 115-a may encode the one or more scrambled message sequences. For example, the UE 115-a may perform non-linear encoding to generate one or more codewords as described with reference to one or more of FIG. 2 and FIG. 3.

At 420, the UE 115-a may scramble one or more codewords. For example, the UE 115-a may scramble one or more codewords (e.g., real numbers) from the non-linear encoding as described with reference to one or more of FIG. 2 and FIG. 3.

At 425, the UE 115-a may transmit a signal to the network entity 105-a. For example, the UE 115-a may transmit a signal indicating the one or more scrambled and encoded message sequences or codewords as described with reference to one or more of FIG. 2 and FIG. 3.

At 430, the network entity 105-a may descramble and decode the signal. For example, the network entity 105-a may descramble and decode the one or more scrambled and encoded message sequences or codewords as described with reference to one or more of FIG. 2 and FIG. 3.

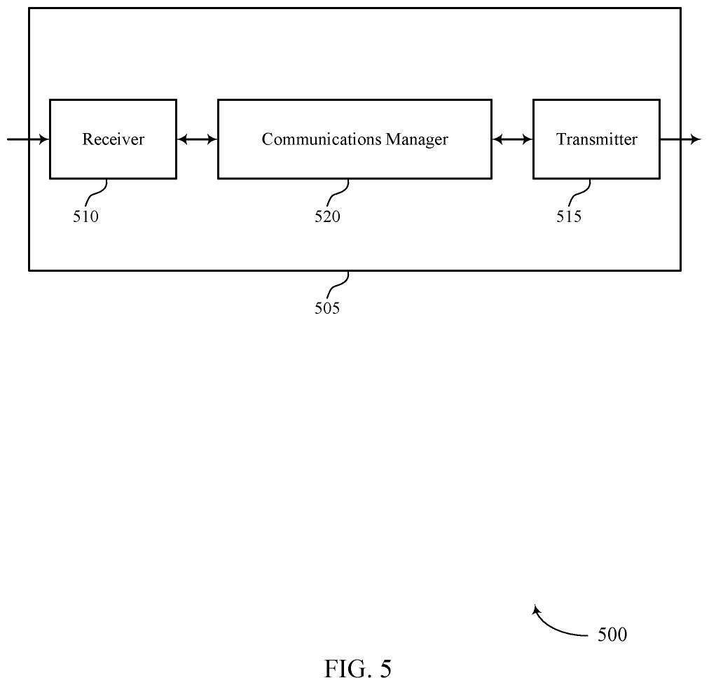

FIG. 5 shows a block diagram 500 of a device 505 that supports scrambling for non-linear channel encoders in accordance with one or more aspects of the present disclosure. The device 505 may be an example of aspects of a wireless device as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to scrambling for non-linear channel encoders). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to scrambling for non-linear channel encoders). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of scrambling for non-linear channel encoders as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

For example, the communications manager 520 is capable of, configured to, or operable to support a means for scrambling a message sequence based on a scrambling configuration. The communications manager 520 is capable of, configured to, or operable to support a means for encoding the scrambled message sequence based on a non-linear channel encoder configured to encode and modulate the scrambled message sequence to generate a codeword. The communications manager 520 is capable of, configured to, or operable to support a means for transmitting a signal based on the codeword generated from the non-linear channel encoder.

For example, the communications manager 520 is capable of, configured to, or operable to support a means for encoding a message sequence based on a non-linear channel encoder configured to encode and modulate the message sequence to generate a codeword. The communications manager 520 is capable of, configured to, or operable to support a means for scrambling the codeword based on a real number output from the non-linear channel encoder. The communications manager 520 is capable of, configured to, or operable to support a means for transmitting a signal based on the scrambled codeword.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, or more efficient utilization of communication resources.

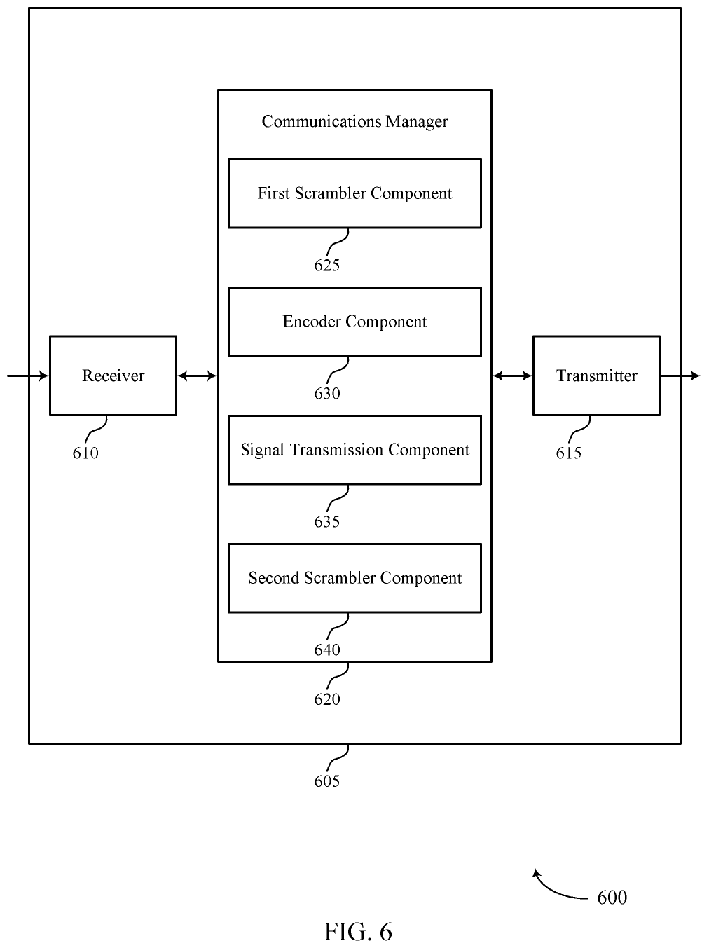

FIG. 6 shows a block diagram 600 of a device 605 that supports scrambling for non-linear channel encoders in accordance with one or more aspects of the present disclosure. The device 605 may be an example of aspects of a device 505, a UE 115, or a network entity 105 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to scrambling for non-linear channel encoders). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to scrambling for non-linear channel encoders). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of scrambling for non-linear channel encoders as described herein. For example, the communications manager 620 may include a first scrambler component 625, an encoder component 630, a signal transmission component 635, a second scrambler component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The first scrambler component 625 is capable of, configured to, or operable to support a means for scrambling a message sequence based on a scrambling configuration. The encoder component 630 is capable of, configured to, or operable to support a means for encoding the scrambled message sequence based on a non-linear channel encoder configured to encode and modulate the scrambled message sequence to generate a codeword. The signal transmission component 635 is capable of, configured to, or operable to support a means for transmitting a signal based on the codeword generated from the non-linear channel encoder.

The encoder component 630 is capable of, configured to, or operable to support a means for encoding a message sequence based on a non-linear channel encoder configured to encode and modulate the message sequence to generate a codeword. The second scrambler component 640 is capable of, configured to, or operable to support a means for scrambling the codeword based on a real number output from the non-linear channel encoder. The signal transmission component 635 is capable of, configured to, or operable to support a means for transmitting a signal based on the scrambled codeword.

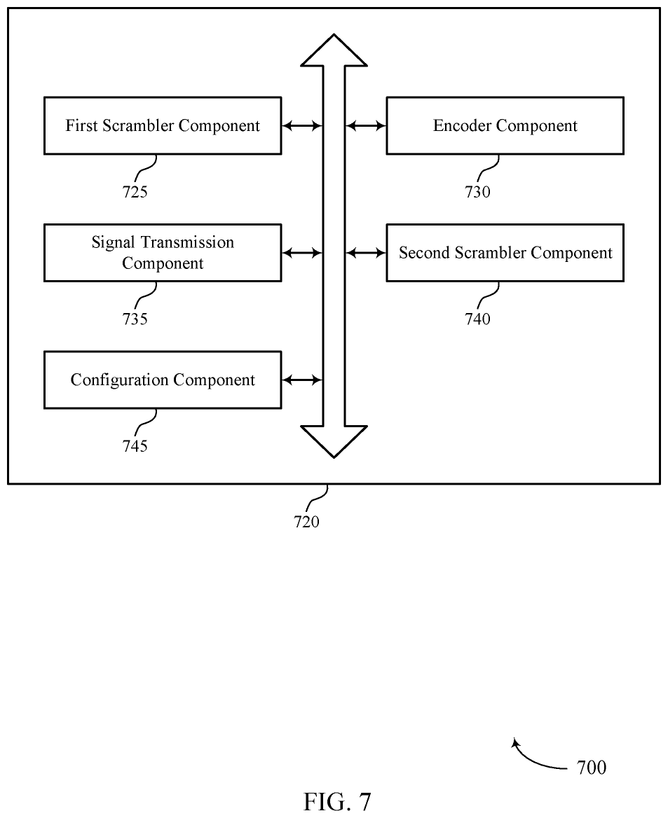

FIG. 7 shows a block diagram 700 of a communications manager 720 that supports scrambling for non-linear channel encoders in accordance with one or more aspects of the present disclosure. The communications manager 720 may be an example of aspects of a communications manager 520, a communications manager 620, or both, as described herein. The communications manager 720, or various components thereof, may be an example of means for performing various aspects of scrambling for non-linear channel encoders as described herein. For example, the communications manager 720 may include a first scrambler component 725, an encoder component 730, a signal transmission component 735, a second scrambler component 740, a configuration component 745, or any combination thereof. Each of these components, or components or subcomponents thereof (e.g., one or more processors, one or more memories), may communicate, directly or indirectly, with one another (e.g., via one or more buses).

The first scrambler component 725 is capable of, configured to, or operable to support a means for scrambling a message sequence based on a scrambling configuration. The encoder component 730 is capable of, configured to, or operable to support a means for encoding the scrambled message sequence based on a non-linear channel encoder configured to encode and modulate the scrambled message sequence to generate a codeword. The signal transmission component 735 is capable of, configured to, or operable to support a means for transmitting a signal based on the codeword generated from the non-linear channel encoder.

In some examples, the configuration component 745 is capable of, configured to, or operable to support a means for communicating the scrambling configuration, the scrambling configuration indicating a change of a scrambling sequence between transmissions, where scrambling the message sequence includes scrambling the message sequence in accordance with the scrambling sequence.

In some examples, scrambling the message sequence is based on a seed for generating pseudorandom information.

In some examples, the first scrambler component 725 is capable of, configured to, or operable to support a means for generating the pseudorandom information based on the seed, the pseudorandom information including a pseudorandom binary sequence, a pseudorandom matrix, a pseudorandom permutation rule, a pseudorandom permutation function, or any combination thereof.

In some examples, the seed is based on a time slot, a subslot, a frame, a subframe, a symbol index, a subcarrier index, a resource block index, an identifier of the wireless device, an identifier of a cell, a transmission index, or any combination thereof associated with transmission of the signal.

In some examples, scrambling the message sequence is performed to reduce a per-message block error rate (BLER) spread of a set of message sequences that includes the message sequence.

In some examples, the second scrambler component 740 is capable of, configured to, or operable to support a means for scrambling the codeword based on a real number output from the non-linear channel encoder, where the signal is based on the scrambled codeword.

In some examples, to support scrambling the codeword, the second scrambler component 740 is capable of, configured to, or operable to support a means for scrambling the codeword based on a pseudorandom phase that is based on a seed.

In some examples, the seed is based on a slot index, a subcarrier index, a location within the codeword, an identifier of a cell, or any combination thereof.

In some examples, to support scrambling the codeword, the second scrambler component 740 is capable of, configured to, or operable to support a means for transforming real numbers of the real number output in the codeword to a complex number. In some examples, to support scrambling the codeword, the second scrambler component 740 is capable of, configured to, or operable to support a means for multiplying the complex number by the pseudorandom phase to generate the scrambled codeword, where the signal is based on the scrambled codeword.

In some examples, the non-linear channel encoder is an artificial intelligence-based channel encoder.

In some examples, the encoder component 730 is capable of, configured to, or operable to support a means for encoding a message sequence based on a non-linear channel encoder configured to encode and modulate the message sequence to generate a codeword. The second scrambler component 740 is capable of, configured to, or operable to support a means for scrambling the codeword based on a real number output from the non-linear channel encoder. In some examples, the signal transmission component 735 is capable of, configured to, or operable to support a means for transmitting a signal based on the scrambled codeword.

In some examples, to support scrambling the codeword, the second scrambler component 740 is capable of, configured to, or operable to support a means for scrambling the codeword based on a pseudorandom phase that is based on a seed.

In some examples, the seed is based on a slot index, a subcarrier index, a location within the codeword, an identifier of a cell, or any combination thereof.

In some examples, to support scrambling the codeword, the second scrambler component 740 is capable of, configured to, or operable to support a means for transforming real numbers of the real number output in the codeword to a complex number. In some examples, to support scrambling the codeword, the second scrambler component 740 is capable of, configured to, or operable to support a means for multiplying the complex number by the pseudorandom phase to generate the scrambled codeword, where the signal is based on the scrambled codeword.

In some examples, the first scrambler component 725 is capable of, configured to, or operable to support a means for scrambling the message sequence based on a scrambling configuration, where encoding the message sequence includes encoding the scrambled message sequence.

In some examples, the configuration component 745 is capable of, configured to, or operable to support a means for communicating the scrambling configuration, the scrambling configuration indicating a change of a scrambling sequence between transmissions, where scrambling the message sequence includes scrambling the message sequence in accordance with the scrambling sequence.

In some examples, scrambling the message sequence is based on a seed for generating pseudorandom information.

In some examples, the first scrambler component 725 is capable of, configured to, or operable to support a means for generating the pseudorandom information based on the seed, the pseudorandom information including a pseudorandom binary sequence, a pseudorandom matrix, a pseudorandom permutation rule, a pseudorandom permutation function, or any combination thereof.

In some examples, the seed is based on a time slot, a subslot, a frame, a subframe, a symbol index, a subcarrier index, a resource block index, an identifier of the wireless device, an identifier of a cell, a transmission index, or any combination thereof associated with transmission of the signal.

In some examples, scrambling the message sequence is performed to reduce a per-message block error rate (BLER) spread of a set of message sequences that includes the message sequence.

In some examples, the non-linear channel encoder is an artificial intelligence-based channel encoder.

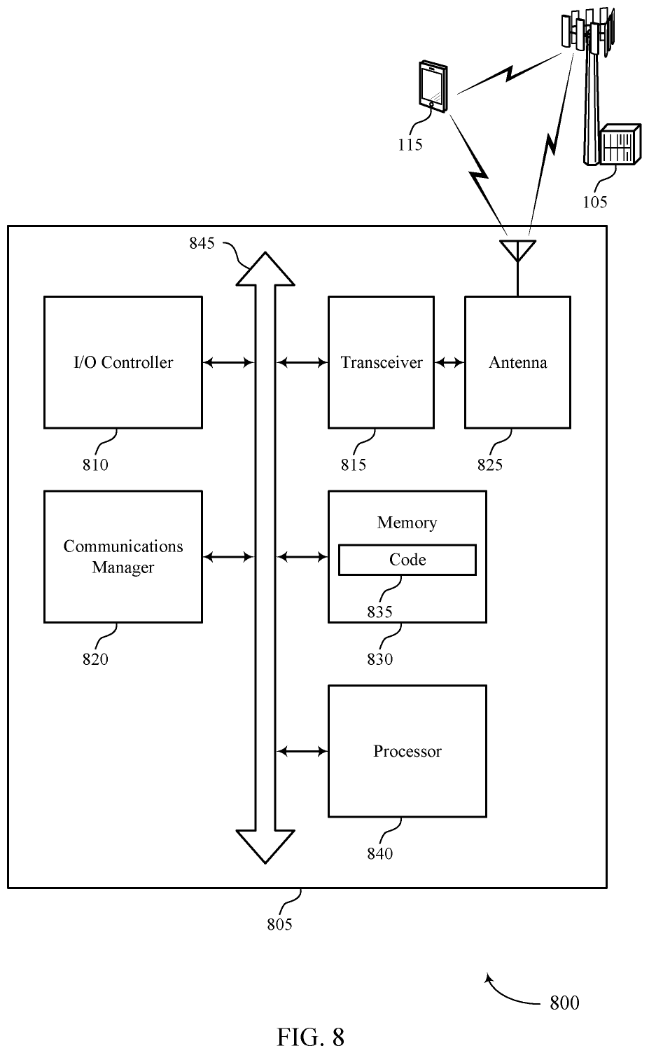

FIG. 8 shows a diagram of a system 800 including a device 805 that supports scrambling for non-linear channel encoders in accordance with one or more aspects of the present disclosure. The device 805 may be an example of or include the components of a device 505, a device 605, or a wireless device as described herein. The device 805 may include components for bi-directional voice and data communications including components for transmitting and receiving communications, such as a communications manager 820, an I/O controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include RAM and ROM. The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a BIOS which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting scrambling for non-linear channel encoders). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

For example, the communications manager 820 is capable of, configured to, or operable to support a means for scrambling a message sequence based on a scrambling configuration. The communications manager 820 is capable of, configured to, or operable to support a means for encoding the scrambled message sequence based on a non-linear channel encoder configured to encode and modulate the scrambled message sequence to generate a codeword. The communications manager 820 is capable of, configured to, or operable to support a means for transmitting a signal based on the codeword generated from the non-linear channel encoder.

For example, the communications manager 820 is capable of, configured to, or operable to support a means for encoding a message sequence based on a non-linear channel encoder configured to encode and modulate the message sequence to generate a codeword. The communications manager 820 is capable of, configured to, or operable to support a means for scrambling the codeword based on a real number output from the non-linear channel encoder. The communications manager 820 is capable of, configured to, or operable to support a means for transmitting a signal based on the scrambled codeword.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, or improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of scrambling for non-linear channel encoders as described herein, or the at least one processor 840 and the at least one memory 830 may be otherwise configured to, individually or collectively, perform or support such operations.

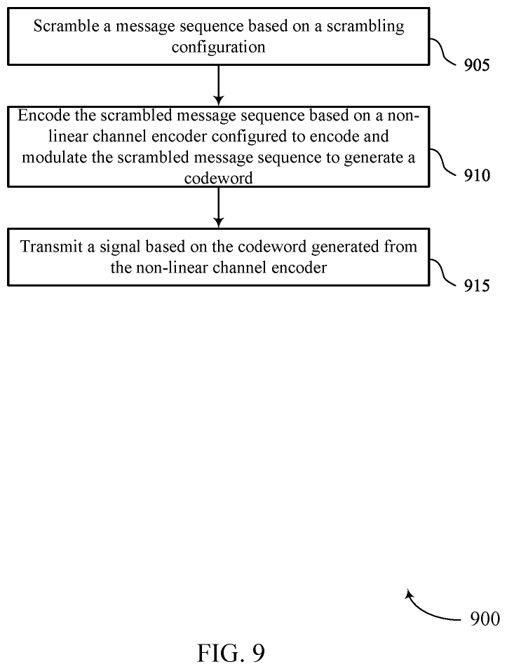

FIG. 9 shows a flowchart illustrating a method 900 that supports scrambling for non-linear channel encoders in accordance with one or more aspects of the present disclosure. The operations of the method 900 may be implemented by a wireless device or its components as described herein. For example, the operations of the method 900 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 905, the method may include scrambling a message sequence based on a scrambling configuration. The operations of block 905 may be performed in accordance with examples as disclosed herein. In some examples, aspects of the operations of 905 may be performed by a first scrambler component 725 as described with reference to FIG. 7.

At 910, the method may include encoding the scrambled message sequence based on a non-linear channel encoder configured to encode and modulate the scrambled message sequence to generate a codeword. The operations of block 910 may be performed in accordance with examples as disclosed herein. In some examples, aspects of the operations of 910 may be performed by an encoder component 730 as described with reference to FIG. 7.

At 915, the method may include transmitting a signal based on the codeword generated from the non-linear channel encoder. The operations of block 915 may be performed in accordance with examples as disclosed herein. In some examples, aspects of the operations of 915 may be performed by a signal transmission component 735 as described with reference to FIG. 7.

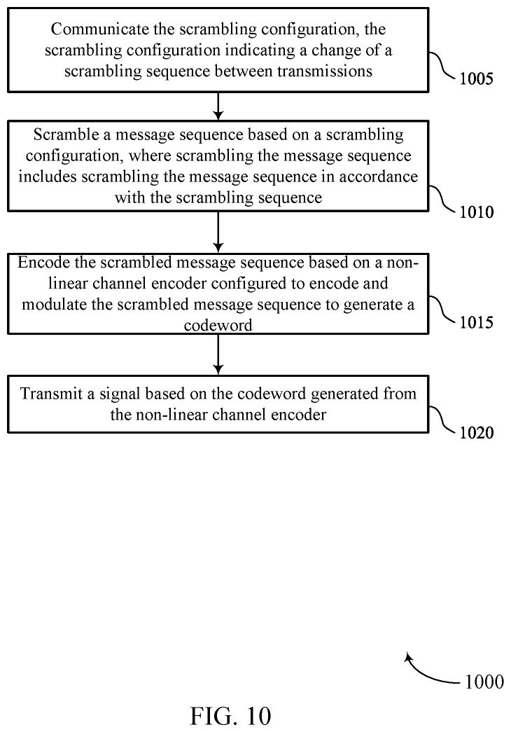

FIG. 10 shows a flowchart illustrating a method 1000 that supports scrambling for non-linear channel encoders in accordance with one or more aspects of the present disclosure. The operations of the method 1000 may be implemented by a wireless device or its components as described herein. For example, the operations of the method 1000 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 1005, the method may include communicating the scrambling configuration, the scrambling configuration indicating a change of a scrambling sequence between transmissions. The operations of block 1005 may be performed in accordance with examples as disclosed herein. In some examples, aspects of the operations of 1005 may be performed by a configuration component 745 as described with reference to FIG. 7.

At 1010, the method may include scrambling a message sequence based on a scrambling configuration, where scrambling the message sequence includes scrambling the message sequence in accordance with the scrambling sequence. The operations of block 1010 may be performed in accordance with examples as disclosed herein. In some examples, aspects of the operations of 1010 may be performed by a first scrambler component 725 as described with reference to FIG. 7.

At 1015, the method may include encoding the scrambled message sequence based on a non-linear channel encoder configured to encode and modulate the scrambled message sequence to generate a codeword. The operations of block 1015 may be performed in accordance with examples as disclosed herein. In some examples, aspects of the operations of 1015 may be performed by an encoder component 730 as described with reference to FIG. 7.

At 1020, the method may include transmitting a signal based on the codeword generated from the non-linear channel encoder. The operations of block 1020 may be performed in accordance with examples as disclosed herein. In some examples, aspects of the operations of 1020 may be performed by a signal transmission component 735 as described with reference to FIG. 7.

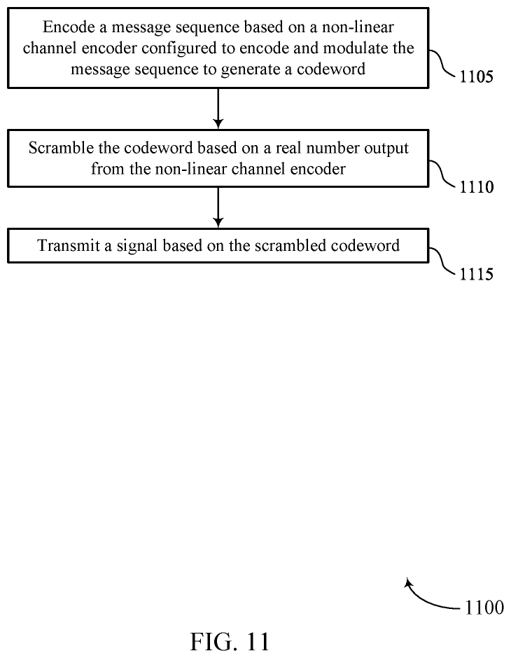

FIG. 11 shows a flowchart illustrating a method 1100 that supports scrambling for non-linear channel encoders in accordance with one or more aspects of the present disclosure. The operations of the method 1100 may be implemented by a wireless device or its components as described herein. For example, the operations of the method 1100 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 1105, the method may include encoding a message sequence based on a non-linear channel encoder configured to encode and modulate the message sequence to generate a codeword. The operations of block 1105 may be performed in accordance with examples as disclosed herein. In some examples, aspects of the operations of 1105 may be performed by an encoder component 730 as described with reference to FIG. 7.

At 1110, the method may include scrambling the codeword based on a real number output from the non-linear channel encoder. The operations of block 1110 may be performed in accordance with examples as disclosed herein. In some examples, aspects of the operations of 1110 may be performed by a second scrambler component 740 as described with reference to FIG. 7.

At 1115, the method may include transmitting a signal based on the scrambled codeword. The operations of block 1115 may be performed in accordance with examples as disclosed herein. In some examples, aspects of the operations of 1115 may be performed by a signal transmission component 735 as described with reference to FIG. 7.

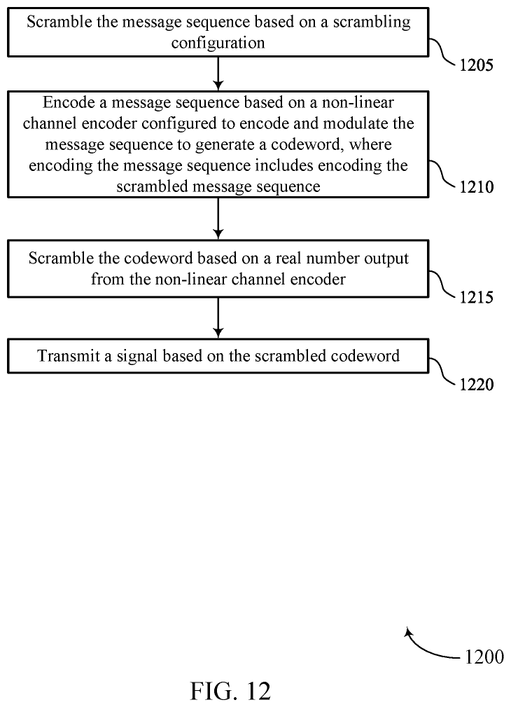

FIG. 12 shows a flowchart illustrating a method 1200 that supports scrambling for non-linear channel encoders in accordance with one or more aspects of the present disclosure. The operations of the method 1200 may be implemented by a wireless device or its components as described herein. For example, the operations of the method 1200 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 1205, the method may include scrambling the message sequence based on a scrambling configuration. The operations of block 1205 may be performed in accordance with examples as disclosed herein. In some examples, aspects of the operations of 1205 may be performed by a first scrambler component 725 as described with reference to FIG. 7.

At 1210, the method may include encoding a message sequence based on a non-linear channel encoder configured to encode and modulate the message sequence to generate a codeword, where encoding the message sequence includes encoding the scrambled message sequence. The operations of block 1210 may be performed in accordance with examples as disclosed herein. In some examples, aspects of the operations of 1210 may be performed by an encoder component 730 as described with reference to FIG. 7.

At 1215, the method may include scrambling the codeword based on a real number output from the non-linear channel encoder. The operations of block 1215 may be performed in accordance with examples as disclosed herein. In some examples, aspects of the operations of 1215 may be performed by a second scrambler component 740 as described with reference to FIG. 7.

At 1220, the method may include transmitting a signal based on the scrambled codeword. The operations of block 1220 may be performed in accordance with examples as disclosed herein. In some examples, aspects of the operations of 1220 may be performed by a signal transmission component 735 as described with reference to FIG. 7.

The following provides an overview of aspects of the present disclosure:

Aspect 1: A method for wireless communications at a wireless device, comprising: scrambling a message sequence based at least in part on a scrambling configuration; encoding the scrambled message sequence based at least in part on a non-linear channel encoder configured to encode and modulate the scrambled message sequence to generate a code word; and transmitting a signal based at least in part on the code word generated from the non-linear channel encoder.

Aspect 2: The method of aspect 1, further comprising: communicating the scrambling configuration, the scrambling configuration indicating a change of a scrambling sequence between transmissions, wherein scrambling the message sequence comprises scrambling the message sequence in accordance with the scrambling sequence.

Aspect 3: The method of any of aspects 1 through 2, wherein scrambling the message sequence is based at least in part on a seed for generating pseudorandom information.

Aspect 4: The method of aspect 3, further comprising: generating the pseudorandom information based at least in part on the seed, the pseudorandom information comprising a pseudorandom binary sequence, a pseudorandom matrix, a pseudorandom permutation rule, a pseudorandom permutation function, or any combination thereof.

Aspect 5: The method of any of aspects 3 through 4, wherein the seed is based at least in part on a time slot, a subslot, a frame, a subframe, a symbol index, a subcarrier index, a resource block index, an identifier of the wireless device, an identifier of a cell, a transmission index, or any combination thereof associated with transmission of the signal.

Aspect 6: The method of any of aspects 1 through 5, wherein scrambling the message sequence is performed to reduce a per-message block error rate (BLER) spread of a set of message sequences that includes the message sequence.

Aspect 7: The method of any of aspects 1 through 6, further comprising: scrambling the code word based at least in part on a real number output from the non-linear channel encoder, wherein the signal is based at least in part on the scrambled code word.

Aspect 8: The method of aspect 7, wherein scrambling the code word comprises: scrambling the code word based at least in part on a pseudorandom phase that is based at least in part on a seed.

Aspect 9: The method of aspect 8, wherein the seed is based at least in part on a slot index, a subcarrier index, a location within the code word, an identifier of a cell, or any combination thereof.

Aspect 10: The method of any of aspects 8 through 9, wherein scrambling the code word comprises: transforming real numbers of the real number output in the code word to a complex number; and multiplying the complex number by the pseudorandom phase to generate the scrambled code word, wherein the signal is based at least in part on the scrambled code word.

Aspect 11: The method of any of aspects 1 through 10, wherein the non-linear channel encoder is an artificial intelligence-based channel encoder.

Aspect 12: A method for wireless communications at a wireless device, comprising: encoding a message sequence based at least in part on a non-linear channel encoder configured to encode and modulate the message sequence to generate a code word; scrambling the code word based at least in part on a real number output from the non-linear channel encoder; and transmitting a signal based at least in part on the scrambled code word.

Aspect 13: The method of aspect 12, wherein scrambling the code word comprises: scrambling the code word based at least in part on a pseudorandom phase that is based at least in part on a seed.

Aspect 14: The method of aspect 13, wherein the seed is based at least in part on a slot index, a subcarrier index, a location within the code word, an identifier of a cell, or any combination thereof.

Aspect 15: The method of any of aspects 13 through 14, wherein scrambling the code word comprises: transforming real numbers of the real number output in the code word to a complex number; and multiplying the complex number by the pseudorandom phase to generate the scrambled code word, wherein the signal is based at least in part on the scrambled code word.

Aspect 16: The method of any of aspects 12 through 15, further comprising: scrambling the message sequence based at least in part on a scrambling configuration, wherein encoding the message sequence comprises encoding the scrambled message sequence.

Aspect 17: The method of aspect 16, further comprising: communicating the scrambling configuration, the scrambling configuration indicating a change of a scrambling sequence between transmissions, wherein scrambling the message sequence comprises scrambling the message sequence in accordance with the scrambling sequence.

Aspect 18: The method of any of aspects 16 through 17, wherein scrambling the message sequence is based at least in part on a seed for generating pseudorandom information.

Aspect 19: The method of aspect 18, further comprising: generating the pseudorandom information based at least in part on the seed, the pseudorandom information comprising a pseudorandom binary sequence, a pseudorandom matrix, a pseudorandom permutation rule, a pseudorandom permutation function, or any combination thereof.

Aspect 20: The method of any of aspects 18 through 19, wherein the seed is based at least in part on a time slot, a subslot, a frame, a subframe, a symbol index, a subcarrier index, a resource block index, an identifier of the wireless device, an identifier of a cell, a transmission index, or any combination thereof associated with transmission of the signal.

Aspect 21: The method of any of aspects 16 through 20, wherein scrambling the message sequence is performed to reduce a per-message block error rate (BLER) spread of a set of message sequences that includes the message sequence.

Aspect 22: The method of any of aspects 12 through 21, wherein the non-linear channel encoder is an artificial intelligence-based channel encoder.

Aspect 23: A wireless device comprising one or more memories storing processor-executable code, and one or more processors coupled with the one or more memories and individually or collectively operable to execute the code to cause the wireless device to perform a method of any of aspects 1 through 11.

Aspect 24: A wireless device comprising at least one means for performing a method of any of aspects 1 through 11.

Aspect 25: A non-transitory computer-readable medium storing code the code comprising instructions executable by one or more processors to perform a method of any of aspects 1 through 11.

Aspect 26: A wireless device comprising one or more memories storing processor-executable code, and one or more processors coupled with the one or more memories and individually or collectively operable to execute the code to cause the wireless device to perform a method of any of aspects 12 through 22.

Aspect 27: A wireless device comprising at least one means for performing a method of any of aspects 12 through 22.

Aspect 28: A non-transitory computer-readable medium storing code the code comprising instructions executable by one or more processors to perform a method of any of aspects 12 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
scramble a message sequence based at least in part on a scrambling configuration;
encode the scrambled message sequence based at least in part on a non-linear channel encoder configured to encode and modulate the scrambled message sequence to generate a codeword; and
transmit a signal based at least in part on the codeword generated from the non-linear channel encoder.

2. The wireless device of claim 1, wherein the one or more processors are individually or collectively further operable to execute the code to cause the wireless device to:
communicate the scrambling configuration, the scrambling configuration indicating a change of a scrambling sequence between transmissions, wherein scrambling the message sequence comprises scrambling the message sequence in accordance with the scrambling sequence.

3. The wireless device of claim 1, wherein scrambling the message sequence is based at least in part on a seed for generating pseudorandom information.

4. The wireless device of claim 3, wherein the one or more processors are individually or collectively further operable to execute the code to cause the wireless device to:
generate the pseudorandom information based at least in part on the seed, the pseudorandom information comprising a pseudorandom binary sequence, a pseudorandom matrix, a pseudorandom permutation rule, a pseudorandom permutation function, or any combination thereof.

5. The wireless device of claim 3, wherein the seed is based at least in part on a time slot, a subslot, a frame, a subframe, a symbol index, a subcarrier index, a resource block index, an identifier of the wireless device, an identifier of a cell, a transmission index, or any combination thereof associated with transmission of the signal.

6. The wireless device of claim 1, wherein scrambling the message sequence is performed to reduce a per-message block error rate (BLER) spread of a set of message sequences that includes the message sequence.

7. The wireless device of claim 1, wherein the one or more processors are individually or collectively further operable to execute the code to cause the wireless device to:
scramble the codeword based at least in part on a real number output from the non-linear channel encoder, wherein the signal is based at least in part on the scrambled codeword.

8. The wireless device of claim 7, wherein, to scramble the codeword, the one or more processors are individually or collectively operable to execute the code to cause the wireless device to:
scramble the codeword based at least in part on a pseudorandom phase that is based at least in part on a seed.

9. The wireless device of claim 8, wherein the seed is based at least in part on a slot index, a subcarrier index, a location within the codeword, an identifier of a cell, or any combination thereof.

10. The wireless device of claim 8, wherein, to scramble the codeword, the one or more processors are individually or collectively operable to execute the code to cause the wireless device to:
transform real numbers of the real number output in the codeword to a complex number; and
multiply the complex number by the pseudorandom phase to generate the scrambled codeword, wherein the signal is based at least in part on the scrambled codeword.

11. The wireless device of claim 1, wherein the non-linear channel encoder is an artificial intelligence-based channel encoder.

12. A wireless device, comprising:
one or more memories storing processor-executable code; and
one or more processors coupled with the one or more memories and individually or collectively operable to execute the code to cause the wireless device to:
encode a message sequence based at least in part on a non-linear channel encoder configured to encode and modulate the message sequence to generate a codeword;
scramble the codeword based at least in part on a real number output from the non-linear channel encoder; and
transmit a signal based at least in part on the scrambled codeword.

13. The wireless device of claim 12, wherein, to scramble the codeword, the one or more processors are individually or collectively operable to execute the code to cause the wireless device to:
scramble the codeword based at least in part on a pseudorandom phase that is based at least in part on a seed.

14. The wireless device of claim 13, wherein the seed is based at least in part on a slot index, a subcarrier index, a location within the codeword, an identifier of a cell, or any combination thereof.

15. The wireless device of claim 13, wherein, to scramble the codeword, the one or more processors are individually or collectively operable to execute the code to cause the wireless device to:
transform real numbers of the real number output in the codeword to a complex number; and
multiply the complex number by the pseudorandom phase to generate the scrambled codeword, wherein the signal is based at least in part on the scrambled codeword.

16. The wireless device of claim 12, wherein the one or more processors are individually or collectively further operable to execute the code to cause the wireless device to:
scramble the message sequence based at least in part on a scrambling configuration, wherein encoding the message sequence comprises encoding the scrambled message sequence.

17. The wireless device of claim 16, wherein the one or more processors are individually or collectively further operable to execute the code to cause the wireless device to:
communicate the scrambling configuration, the scrambling configuration indicating a change of a scrambling sequence between transmissions, wherein scrambling the message sequence comprises scrambling the message sequence in accordance with the scrambling sequence.

18. The wireless device of claim 16, wherein scrambling the message sequence is based at least in part on a seed for generating pseudorandom information.

19. The wireless device of claim 18, wherein the one or more processors are individually or collectively further operable to execute the code to cause the wireless device to:
generate the pseudorandom information based at least in part on the seed, the pseudorandom information comprising a pseudorandom binary sequence, a pseudorandom matrix, a pseudorandom permutation rule, a pseudorandom permutation function, or any combination thereof.

20. The wireless device of claim 18, wherein the seed is based at least in part on a time slot, a subslot, a frame, a subframe, a symbol index, a subcarrier index, a resource block index, an identifier of the wireless device, an identifier of a cell, a transmission index, or any combination thereof associated with transmission of the signal.

21. The wireless device of claim 16, wherein scrambling the message sequence is performed to reduce a per-message block error rate (BLER) spread of a set of message sequences that includes the message sequence.

22. The wireless device of claim 12, wherein the non-linear channel encoder is an artificial intelligence-based channel encoder.

23. A method for wireless communications at a wireless device, comprising:
scrambling a message sequence based at least in part on a scrambling configuration;
encoding the scrambled message sequence based at least in part on a non-linear channel encoder configured to encode and modulate the scrambled message sequence to generate a codeword; and
transmitting a signal based at least in part on the codeword generated from the non-linear channel encoder.

24. The method of claim 23, further comprising:
communicating the scrambling configuration, the scrambling configuration indicating a change of a scrambling sequence between transmissions, wherein scrambling the message sequence comprises scrambling the message sequence in accordance with the scrambling sequence.

25. The method of claim 23, wherein scrambling the message sequence is based at least in part on a seed for generating pseudorandom information.

26. The method of claim 23, wherein scrambling the message sequence is performed to reduce a per-message block error rate (BLER) spread of a set of message sequences that includes the message sequence.

27. The method of claim 23, further comprising:
scrambling the codeword based at least in part on a real number output from the non-linear channel encoder, wherein the signal is based at least in part on the scrambled codeword.

28. A method for wireless communications at a wireless device, comprising:
encoding a message sequence based at least in part on a non-linear channel encoder configured to encode and modulate the message sequence to generate a codeword;
scrambling the codeword based at least in part on a real number output from the non-linear channel encoder; and
transmitting a signal based at least in part on the scrambled codeword.

29. The method of claim 28, wherein scrambling the codeword comprises:
scrambling the codeword based at least in part on a pseudorandom phase that is based at least in part on a seed.

30. The method of claim 28, further comprising:
scrambling the message sequence based at least in part on a scrambling configuration, wherein encoding the message sequence comprises encoding the scrambled message sequence.
